(19) United States
(12) Patent Application Publication
(10) Pub. No.: US 2026/0181642 A1
(43) Pub. Date: Jun. 25, 2026

(54) METHOD AND APPARATUS FOR SWITCHING BWP, AND COMMUNICATION DEVICE AND STORAGE MEDIUM

(71) Applicant: Beijing Xiaomi Mobile Software Co., Ltd., Beijing (CN)

(72) Inventors: Juan ZHANG, Beijing (CN); Qin MU, Beijing (CN)

(73) Assignee: Beijing Xiaomi Mobile Software Co., Ltd., Beijing (CN)

(21) Appl. No.: 18/729,588

(22) PCT Filed: Jan. 20, 2022
(86) PCT No.: PCT/CN2022/073058

§ 371 Date: Jul. 17, 2024

(51) Int. Cl. H04W 72/23; H04L 5/00; H04W 72/0453; H04W 72/12

(52) U.S. Cl. CPC H04W 72/23; H04L 5/0092; H04L 5/0094; H04W 72/0453; H04W 72/12

(57) ABSTRACT

Provided in the embodiments of the present disclosure is a method for switching a bandwidth part (BWP). The method is executed by a terminal and includes determining a switching mode for switching the BWP, wherein the switching mode includes a first switching mode for switching a downlink BWP or an uplink BWP and a second switching mode for switching the downlink BWP and the uplink BWP.

### CROSS REFERENCE TO RELATED APPLICATION

The present application is a U.S. National Stage of International Application No. PCT/CN2022/073058, filed on Jan. 20, 2022, the content of which is incorporated by reference herein in its entirety.

### TECHNICAL FIELD

The present disclosure relates to the field of wireless communication technology but is not limited to the field of wireless communication technology, and in particular to method, and apparatus for switching BWP, communication device and storage medium.

### BACKGROUND

In the process of continuous network evolution, a new terminal, namely, a reduced capability (Redcap) terminal, has been introduced. This type of terminal is different from ordinary terminals, for example, different from enhanced mobile broadband (eMBB) terminals. This type of terminal usually needs to meet the following requirements: 1. low cost and low complexity; 2. a certain degree of coverage enhancement; and 3. power saving.

In the related art, for RedCap terminals, the bandwidth is reduced, and when switching bandwidth part (BWP), the center frequency point may shift. This will result in the interval of the BWP frequency points fail not meeting the relevant requirement, leading to the inability to realize the simultaneous reception and transmission of data, making wireless communication unreliable.

### SUMMARY

The embodiments of the present disclosure provide methods and apparatuses for switching a bandwidth part (BWP), communication devices and non-transitory computer-readable storage medium.

According to a first aspect of the embodiments of the present disclosure, there is provided a method for switching a BWP. The method is performed by a terminal and includes determining a switching mode for switching the BWP. The switching mode includes a first switching mode for switching a downlink BWP or an uplink BWP and a second switching mode for switching the downlink BWP and the uplink BWP.

According to a second aspect of the embodiments of the present disclosure, there is provided a method for switching a BWP. The method is performed by a base station and includes determining a switching mode for switching the BWP. The switching mode includes a first switching mode for switching a downlink BWP or an uplink BWP and a second switching mode for switching the downlink BWP and the uplink BWP. The method further includes sending information indicating the switching mode to a terminal.

According to a third aspect of the embodiments of the present disclosure, there is provided a device for switching a BWP. The method includes a processing module configured to determine a switching mode for switching the BWP. The switching mode includes a first switching mode for switching a downlink BWP or an uplink BWP and a second switching mode for switching the downlink BWP and the uplink BWP.

According to a fourth aspect of the embodiments of the present disclosure, there is provided a device for switching a BWP. The device includes a processing module configured to determine a switching mode for switching the BWP. The switching mode includes a first switching mode for switching a downlink BWP or an uplink BWP and a second switching mode for switching the downlink BWP and the uplink BWP. The device further includes a sending module configured to send information indicating the switching mode to a terminal.

According to a fifth aspect of the embodiments of the present disclosure, there is provided a communication device including a processor and a memory for storing instructions executable by the processor. The processor is configured to execute the executable instructions stored on the memory and to implement the method according to any of the embodiments of the present disclosure.

According to a sixth aspect of the embodiments of the present disclosure, there is provided a non-transitory computer-readable storage medium. The non-transitory computer-readable storage medium stores computer executable instructions, and the computer executable instructions implement the method according to any of the embodiments of the present disclosure after being executed by a processor.

### BRIEF DESCRIPTION OF THE DRAWINGS

FIG. 1 is a structural diagram of a wireless communication system according to an exemplary embodiment.

FIG. 2 is a schematic diagram of a frequency interval of a BWP according to an exemplary embodiment.

FIG. 3 is a schematic diagram of a frequency interval of a BWP according to an exemplary embodiment.

FIG. 4 is a schematic diagram of a frequency interval of a BWP according to an exemplary embodiment.

FIG. 5 is a schematic diagram of a frequency interval of a BWP according to an exemplary embodiment.

FIG. 6 is a schematic diagram of a frequency interval of a BWP according to an exemplary embodiment.

FIG. 7 is a schematic diagram of a frequency interval of a BWP according to an exemplary embodiment.

FIG. 8 is a schematic diagram of a frequency interval of a BWP according to an exemplary embodiment.

FIG. 9 is a schematic diagram of a frequency interval of a BWP according to an exemplary embodiment.

FIG. 10 is a schematic diagram of a frequency interval of a BWP according to an exemplary embodiment.

FIG. 11 is a flowchart of a method for switching a BWP according to an exemplary embodiment.

FIG. 12 is a flowchart of a method for switching a BWP according to an exemplary embodiment.

FIG. 13 is a flowchart of a method for switching a BWP according to an exemplary embodiment.

FIG. 14 is a flowchart of a method for switching a BWP according to an exemplary embodiment.

FIG. 15 is a flow chart of a method for switching BWP according to an exemplary embodiment.

FIG. 16 is a structural diagram of a device for switching BWP according to an exemplary embodiment.

FIG. 17 is a structural diagram of a device for switching BWP according to an exemplary embodiment.

FIG. 18 is a structural diagram of a terminal according to an exemplary embodiment.

FIG. 19 is a block diagram of a base station according to an exemplary embodiment.

### DETAILED DESCRIPTION

Here, exemplary embodiments will be described in detail, examples of which are shown in the accompanying drawings. When the following description refers to the drawings, unless otherwise indicated, the same numbers in different drawings represent the same or similar elements. The embodiments described in the following exemplary embodiments do not represent all embodiments consistent with the embodiments of the present disclosure. Instead, they are only examples of devices and methods consistent with some aspects of the embodiments of the present disclosure as detailed in the attached claims.

The terms used in the embodiments of the present disclosure are only for the purpose of describing specific embodiments and are not intended to limit the embodiments of the present disclosure. The singular forms “one” and “the” used in the embodiments of the present disclosure and the attached claims are also intended to include the plural forms unless the context clearly indicates other meanings. It should also be understood that the term “and/or” used herein refers to and includes any or all possible combinations of one or more associated listed items.

It should be understood that although the terms first, second, third, etc. may be used in the embodiments of the present disclosure to describe various information, this information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein can be interpreted as “at the time of” or “when” or “in response to determining”.

For the purpose of simplicity and ease of understanding, the terms used herein to characterize the size relationship are “greater than” or “less than”. However, for those skilled in the art, it can be understood that the term “greater than” also covers the meaning of “greater than or equal to”, and “less than” also covers the meaning of “less than or equal to”.

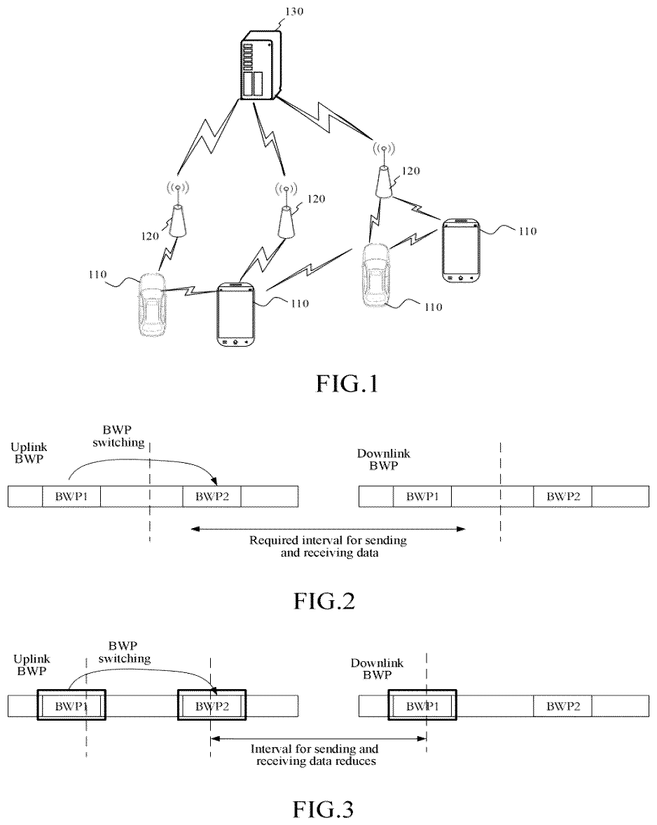

Please refer to FIG. 1, which shows a structural schematic diagram of a wireless communication system provided by an embodiment of the present disclosure. As shown in FIG. 1, the wireless communication system is a communication system based on mobile communication technology, and the wireless communication system may include: a number of user equipment 110 and a number of base stations 120.

The user equipment 110 may be a device that provides voice and/or data connectivity to a user. The user equipment 110 can communicate with one or more core networks via a radio access network (RAN). The user equipment 110 may be an Internet of Things user equipment, such as a sensor device, a mobile phone, and a computer with an Internet of Things user equipment. For example, the user equipment 110 may be a fixed, portable, pocket-sized, handheld, computer-built-in or vehicle-mounted device. For example, the user equipment 110 may be station (STA), subscriber unit, subscriber station, mobile station, mobile, remote station, access point, remote terminal, access terminal, user terminal, user agent, user device, or user equipment. Alternatively, the user equipment 110 may also be a device of an unmanned aerial vehicle. Alternatively, the user equipment 110 may also be a vehicle-mounted device, such as a driving computer with wireless communication function, or a wireless user device connected to an external driving computer. Alternatively, the user equipment 110 may also be a roadside device, such as a street lamp, a signal lamp or other roadside device with wireless communication function.

The base station 120 may be a network-side device in a wireless communication system. The wireless communication system may be a 4th generation mobile communication (4G) system, also known as a long-term evolution (LTE) system; or, the wireless communication system may be a 5G system, also known as a new radio system or a 5G NR system. Alternatively, the wireless communication system may be a next generation system of the 5G system. The access network in the 5G system may be referred to as NG-RAN (New Generation-Radio Access Network).

The base station 120 may be an evolved base station (eNB) used in a 4G system. Alternatively, the base station 120 may also be a base station (gNB) using a centralized distributed architecture in a 5G system. When the base station 120 uses a centralized distributed architecture, it generally includes a centralized unit (CU) and at least two distributed units (DU). The centralized unit is provided with a protocol stack of a packet data convergence protocol (PDCP) layer, a radio link layer control protocol (RLC) layer, and a media access control (MAC) layer. The distributed unit is provided with a physical (PHY) layer protocol stack. The specific implementation method of the base station 120 is not limited in the embodiment of the present disclosure.

A wireless connection can be established between the base station 120 and the user equipment 110 through an air interface. In different implementations, the air interface is an air interface based on the fourth-generation mobile communication network technology (4G) standard; or, the air interface is an air interface based on the fifth-generation mobile communication network technology (5G) standard. For example, the air interface is a new radio. Or, the air interface can also be an air interface based on the next generation mobile communication network technology standard of 5G.

In some embodiments, an E2E (End to End) connection can also be established between the user equipment 110, for example, in the scenario such as V2V (vehicle to vehicle) communication, V2I (vehicle to infrastructure) communication and V2P (vehicle to pedestrian) communication in vehicle to everything (V2X) communication.

Here, the user equipment can be considered as the terminal device of the following embodiments.

In some embodiments, the wireless communication system can also include a network management device 130.

Several base stations 120 are respectively connected to the network management device 130. The network management device 130 can be a core network device in the wireless communication system. For example, the network management device 130 can be a mobility management entity (MME) in the evolved packet core (EPC). Alternatively, the network management device may also be other core network devices, such as a Serving GateWay (SGW), a Public Data Network GateWay (PGW), a Policy and Charging Rules Function (PCRF), or a Home Subscriber Server (HSS). The present disclosure embodiment does not limit the implementation form of the network management device 130.

In order to facilitate the understanding of those skilled in the art, the embodiment of the present disclosure lists multiple implementation methods to clearly illustrate the technical solution of the embodiment of the present disclosure. Of course, those skilled in the art can understand that the multiple embodiments provided in the embodiments of the present disclosure can be executed separately, or can be executed together with the methods of other embodiments in the embodiments of the present disclosure, or can be executed separately or in combination with some methods in other related technologies; the present disclosure embodiment does not limit this.

In order to better understand the technical solution described in any embodiment of the present disclosure, first, the application scenarios in the related art are explained:

In the New Radio (NR) system, the maximum bandwidth of an ordinary terminal in the frequency range FR1 can reach 100 MHz, and the maximum bandwidth in the frequency range FR2 is up to 400 MHz.

In some embodiments, the center frequency interval of the downlink reception and uplink transmission of the frequency division duplexing (FDD) frequency band in the frequency range FR1 must meet the conditions in Table 1.

TABLE 1
Frequency intervals for terminal transmission and reception

| | |
|---|---|
| Operating frequency | Interval between center frequencies of |
| band of NR | transmit and receive carriers |

| n1 | 190 | MHz |
|---|---|---|
| n2 | 80 | MHz |
| n3 | 95 | MHz |
| n5 | 45 | MHz |
| n7 | 120 | MHz |
| n8 | 45 | MHz |
| n12 | 30 | MHz |
| n13 | −31 | MHz |
| n14 | −30 | MHz |
| n18 | 45 | MHz |
| n20 | −41 | MHz |
| n24 | −101.5, −120.5 MHz | |
| n25 | 80 | MHz |
| n26 | 45 | MHz |
| n28 | 55 | MHz |
| n30 | 45 | MHz |
| n65 | 190 | MHz |
| n66 | 400 | MHz |
| n70 | 300 | MHz |
| n71 | −46 | MHz |
| n74 | 48 | MHz |
| n85 | 30 | MHz |

| | |
|---|---|
| n91 | 570 MHz-595 MHz |
| n92 | 575 MHz-680 MHz (μ = 0) |
| | 580 MHz-675 MHz (μ = 1) |
| n93 | 517 MHz-547 MHz |
| n94 | 522 MHz-632 MHz (μ = 0) |
| | 527 MHz-627 MHz (μ = 1) |

In one embodiment, referring to FIG. 2, the maximum bandwidth of an ordinary terminal in the frequency range FR1 can reach 100 MHz, and the channel bandwidth on the terminal side can be as large as the system bandwidth. Therefore, in the FDD system, the downlink DL BWP and the uplink UL BWP are switched independently, and it can still be ensured that the interval between the center frequencies of the switched BWP meets the relevant requirement.

However, referring to FIG. 3, for the RedCap terminal, the maximum bandwidth can only reach 20 MHz. The terminal bandwidth is reduced, and the switching of the BWP bandwidth will bring about the switching of the center frequencies of the transmission and reception. If the downlink BWP is allowed to switch arbitrarily within the system bandwidth, the frequency interval for the transmission and reception on the terminal side will not meet the requirement of interval for the transmission and reception. When the interval for the transmission and reception cannot meet the requirement, the problem of not being able to send and receive data at the same time will occur.

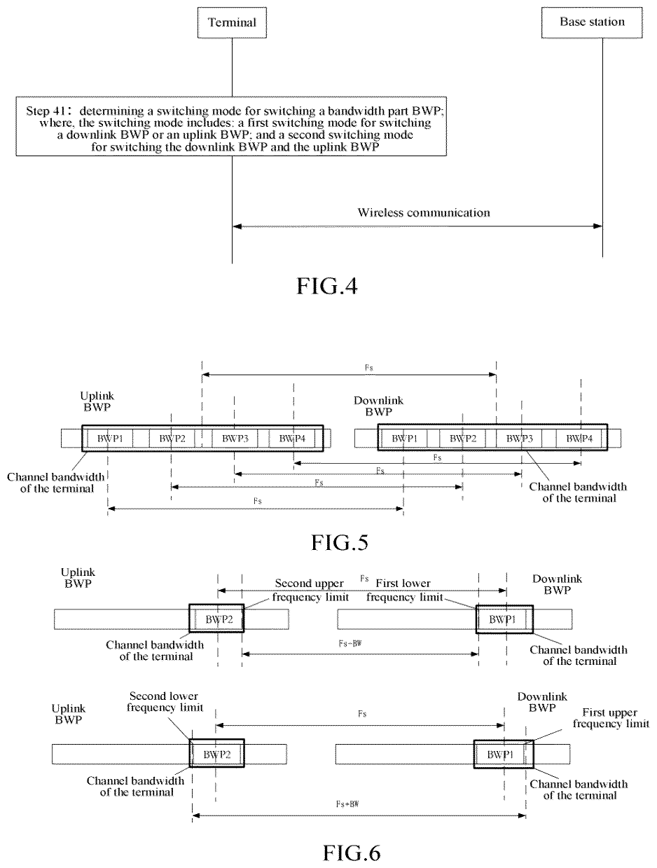

As shown in FIG. 4, a method for switching BWP is provided in an embodiment. The method includes:
Step 41, determining a switching mode for switching a bandwidth part BWP;
where, the switching mode includes: a first switching mode for switching a downlink BWP or an uplink BWP; and a second switching mode for switching the downlink BWP and the uplink BWP.

In one embodiment, determining the switching mode for switching the bandwidth part BWP includes:
determining the switching mode for switching the BWP according to a predetermined condition;
where, the predetermined condition includes: an interval between a reference frequency of a target uplink BWP for performing BWP switching based on the first switching mode and a reference frequency of an activated downlink BWP is within a threshold range; or, an interval between a reference frequency of a target downlink BWP for performing BWP switching based on the first switching mode and a reference frequency of an activated uplink BWP is within a threshold range.

It should be noted that the threshold range can be a predetermined numerical range. For example, the threshold range can be a predetermined numerical range greater than a predetermined value, or a range greater than a first predetermined value and less than a second predetermined value, which is not limited here. In order to better understand the threshold range, two examples are used for explanation below:

For example, a required minimum value of the interval between the uplink BWP and the downlink BWP is a, then the threshold range can be: X≥a. Here, the interval is within the threshold range, then the interval≥a.

For example, a required minimum value of the interval between the uplink BWP and the downlink BWP is a, then the threshold range can be: a≤X≤b. Here, if the interval is within the threshold range, then a≤interval≤b.

Here, the method for switching BWP described in any embodiment of the present disclosure can be executed by the terminal, but is not limited to being executed by the terminal, and can also be executed by the base station or other network communication nodes in the core network, which is not limited here. It should be noted that the indication of using the terminal as the execution subject in the present disclosure does not limit the technical solution of the present disclosure.

In one embodiment, the method is executed by the terminal. For example, the terminal determines the switching mode for switching the bandwidth part BWP. The switching mode includes: a first switching mode for switching the downlink BWP or the uplink BWP; and a second switching mode for switching the downlink BWP and the uplink BWP. The terminal sends information indicating the switching mode to the base station. The base station receives the information indicating the switching mode sent by the terminal. The base station performs BWP switching based on the switching mode indicated by the information of the switching mode.

In one embodiment, the method is executed by the base station. For example, the base station determines the switching mode for switching the bandwidth part BWP. The switching mode includes: a first switching mode for switching the downlink BWP or the uplink BWP; and a second switching mode for switching the downlink BWP and the uplink BWP. The base station sends information indicating the switching mode to the terminal. The terminal receives information indicating the switching mode sent by the base station. The terminal performs BWP switching based on the switching mode indicated by the information of the switching mode.

Here, the terminal involved in the present disclosure may be, but is not limited to, a mobile phone, a wearable device, a vehicle-mounted terminal, a road side unit (RSU, Road Side Unit), a smart home terminal, an industrial sensor device and/or a medical device, etc. In some embodiments, the terminal may be a Redcap terminal or a new radio NR terminal of a predetermined version (for example, an NR terminal of R17).

The base station involved in the present disclosure may be an access device for the terminal to access the network. Here, the base station may be various types of base stations, for example, a base station of a third-generation mobile communication (3G) network, a base station of a fourth-generation mobile communication (4G) network, a base station of a fifth-generation mobile communication (5G) network, or other evolved base stations.

In one embodiment, the terminal is currently operating in an activated uplink BWP and an activated downlink BWP and needs to perform an uplink BWP switch. If the interval between the reference frequency of the target uplink BWP for performing BWP switching based on the first switching mode and the reference frequency of the activated downlink BWP is within the threshold range, the BWP switching mode is determined to be the first switching mode; and the BWP switching is performed based on the first switching mode. For example, performing BWP switching based on the first switching mode may be: only switching the uplink BWP, that is, switching the uplink BWP to the target uplink BWP, while the downlink BWP is not switched. Here, only switching the uplink BWP can also be understood as: performing an independent switching of the uplink BWP.

In one embodiment, the terminal is currently operating in an activated uplink BWP and an activated downlink BWP and needs to perform an uplink BWP switch. If the interval between the reference frequency of the target uplink BWP for performing BWP switching based on the first switching mode and the reference frequency of the activated downlink BWP is not within the threshold range, the BWP switching mode is determined to be the second mode; and the BWP switching is performed based on the second mode. For example, performing BWP switching based on the second mode may be: switching the uplink BWP and the downlink BWP, that is, switching the uplink BWP to the target uplink BWP, and switching the downlink BWP to the target downlink BWP. Here, switching the uplink BWP and the downlink BWP may be understood as: performing synchronous switching of the uplink BWP and the downlink BWP.

In one embodiment, the terminal is currently operating in an activated uplink BWP and an activated downlink BWP and needs to perform downlink BWP switching. If the interval between the reference frequency of the target downlink BWP for performing BWP switching based on the first switching mode and the reference frequency of the activated uplink BWP is within the threshold range, the BWP switching mode is determined to be the first switching mode; and BWP switching is performed based on the first switching mode. For example, performing BWP switching based on the first switching mode may be: only switching the downlink BWP, that is, switching the downlink BWP to the target downlink BWP, while the uplink BWP is not switched. Here, only switching the downlink BWP can also be understood as: performing an independent switching of the downlink BWP.

In one embodiment, the terminal is currently operating in an activated uplink BWP and an activated downlink BWP and needs to perform a downlink BWP switching. If the interval between the reference frequency of the target downlink BWP for performing BWP switching based on the first switching mode and the reference frequency of the activated uplink BWP is not within the threshold range, the BWP switching mode is determined to be the second mode; and the BWP switching is performed based on the second mode. For example, performing BWP switching based on the second mode may be: switching the uplink BWP and the downlink BWP, that is, switching the uplink BWP to the target uplink BWP, and switching the downlink BWP to the target downlink BWP. Here, switching the uplink BWP and the downlink BWP may be understood as: performing synchronous switching of the uplink BWP and the downlink BWP.

In one embodiment, the downlink BWP and the uplink BWP configured with the same BWP identification ID meet the preset interval requirement for sending and receiving data. Here, meeting the preset interval requirement for sending and receiving data may be that the interval between the center frequency of the downlink BWP and the center frequency of the uplink BWP is a predetermined interval. For example, the predetermined interval is Fs. Referring to FIG. 5, the interval between the center frequency of BWP1 in the uplink BWP and the center frequency of BWP1 in the downlink BWP is Fs; the interval between the center frequency of BWP2 in the uplink BWP and the center frequency of BWP2 in the downlink BWP is Fs; the interval between the center frequency of BWP3 in the uplink BWP and the center frequency of BWP3 in the downlink BWP is Fs; and the interval between the center frequency of BWP4 in the uplink BWP and the center frequency of BWP4 in the downlink BWP is Fs.

In one embodiment, in response to not meeting the predetermined condition, the switching mode for switching bandwidth part BWP is determined to be the second mode. When the terminal receives the downlink scheduling downlink control information (DCI, Downlink Control Information), the downlink BWP and the uplink BWP are switched simultaneously based on the second mode. In one embodiment, the BWP identifications of the target downlink BWP and the target uplink BWP for switching are the same. That is, after the switching is completed, the BWP identifications of the activated target downlink BWP and the activated uplink BWP are the same.

In one embodiment, in response to not meeting the predetermined condition, the switching mode for switching bandwidth part BWP is determined to be the second mode. When the terminal receives the uplink scheduling DCI, the downlink BWP and the uplink BWP are switched simultaneously based on the second mode. In one embodiment, the BWP identifications of the target downlink BWP and the target uplink BWP for switching are the same. That is, after the switching is completed, the BWP identifications of the activated target downlink BWP and the activated uplink BWP are the same.

In one embodiment, in response to not meeting the predetermined condition, the switching mode for switching bandwidth part BWP is determined to be second mode. When the terminal receives the downlink scheduling downlink control information (DCI), the downlink BWP and the uplink BWP are switched simultaneously based on the second mode. In one embodiment, in response to switching the BWP based on the second switching mode, the BWP is switched to the target uplink BWP and the target downlink BWP based on the second switching mode. The interval between the first lower frequency limit of the target downlink BWP and the second upper frequency limit of the target uplink BWP is greater than or equal to the first predetermined value, and/or the interval between the first upper frequency limit of the target downlink BWP and the second lower frequency limit of the target uplink BWP is less than or equal to the second predetermined value.

In one embodiment, in response to meeting the predetermined condition, the switching mode for switching bandwidth part BWP is determined to be the first switching mode. When the terminal receives the downlink scheduling DCI, the downlink BWP is switched and the uplink BWP is not switched based on the first switching mode.

In one embodiment, in response to meeting the predetermined condition, the switching mode for switching bandwidth part BWP is determined to be the first switching mode. When the terminal receives the uplink scheduling DCI, the downlink BWP is not switched and the uplink BWP is switched based on the first switching mode.

In one embodiment, the reference frequency of the target uplink BWP for BWP switching based on the first switching mode may be the center frequency of the target uplink BWP. The reference frequency of the activated downlink BWP may be the center frequency of the activated downlink BWP.

In one embodiment, the reference frequency of the target downlink BWP for BWP switching based on the first switching mode may be the center frequency of the target downlink BWP. The reference frequency of the activated uplink BWP may be the center frequency of the activated uplink BWP. In one embodiment, the terminal currently uses the uplink BWP and the downlink BWP. If it is triggered to switch the uplink BWP, this is the scenario of switching the current uplink BWP. For the scenario where the current uplink BWP needs to be switched, the uplink BWP to be switched to is the target uplink BWP. Referring to FIG. 6, the reference frequency of the target uplink BWP for performing BWP switching based on the first switching mode may include the second upper frequency limit of the BWP and the second lower frequency limit of the BWP. Here, the second upper frequency limit may be the highest frequency of the BWP, and the second lower frequency limit may be the lowest frequency of the BWP. The reference frequency of the activated downlink BWP may include the first upper frequency limit and the first lower frequency limit of the BWP. Here, the first upper frequency limit may be the highest frequency of the BWP, and the first lower frequency limit may be the lowest frequency of the BWP.

For example, for the scenario where the current uplink BWP needs to be switched, please refer to FIG. 6. Under the predetermined bandwidth, the preset interval for sending and receiving data is Fs MHz (Tx-Rx separation), and the channel bandwidth of the terminal is BW. If the interval between the first lower frequency limit and the second upper frequency limit is greater than X1, where X1=Fs−BW; and/or the interval between the first upper frequency limit and the second lower frequency limit is less than X2, where X2=Fs+BW, then the predetermined condition is met.

In one embodiment, the terminal currently uses the uplink BWP and the downlink BWP. If it is triggered to switch the downlink BWP, this is a scenario for switching the current downlink BWP. For the scenario where the current downlink BWP needs to be switched, the downlink BWP to be switched to is the target downlink BWP. Referring to FIG. 6, the reference frequency of the target downlink BWP for performing BWP switching based on the first switching mode may include the second upper frequency limit of the BWP and the second lower frequency limit of the BWP. Here, the second upper frequency limit may be the highest frequency of the BWP, and the second lower frequency limit may be the lowest frequency of the BWP. The reference frequency of the activated uplink BWP may include the first upper frequency limit and the first lower frequency limit of the BWP. Here, the first upper frequency limit may be the highest frequency of the BWP, and the first lower frequency limit may be the lowest frequency of the BWP.

For example, for the scenario where the current downlink BWP needs to be switched, please refer to FIG. 6. Under the predetermined bandwidth, the preset interval for sending and receiving data is Fs MHz (Tx-Rx separation), and the channel bandwidth of the terminal is BW. If the interval between the first lower frequency limit and the second upper frequency limit is greater than X1, where X3-Fs-BW; and/or, the interval between the first upper frequency limit and the second lower frequency limit is less than X4, where X4=Fs+BW, then the predetermined condition is met.

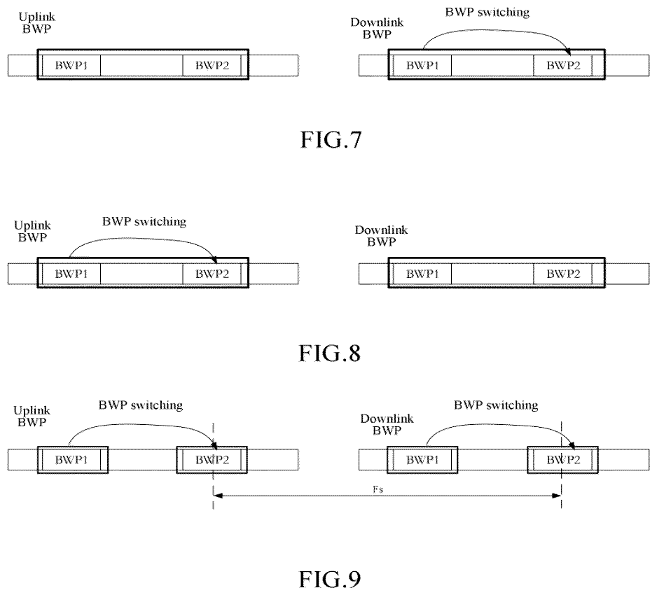

In one embodiment, referring to FIG. 7, in response to determining that the mode for switching BWP is the first switching mode, when switching the downlink BWP to the target downlink BWP, the uplink BWP remains unchanged.

In one embodiment, referring to FIG. 8, in response to determining that the mode for switching BWP is the first switching mode, when switching the uplink BWP to the target uplink BWP, the downlink BWP remains unchanged.

In one embodiment, referring to FIG. 9, in response to determining that the mode for switching BWP is the second mode, when switching the downlink BWP to the target downlink BWP, the uplink BWP needs to be switched at the same time. For example, under a predetermined bandwidth, the interval between the center frequencies of the target downlink BWP and the target uplink BWP is Fs MHz.

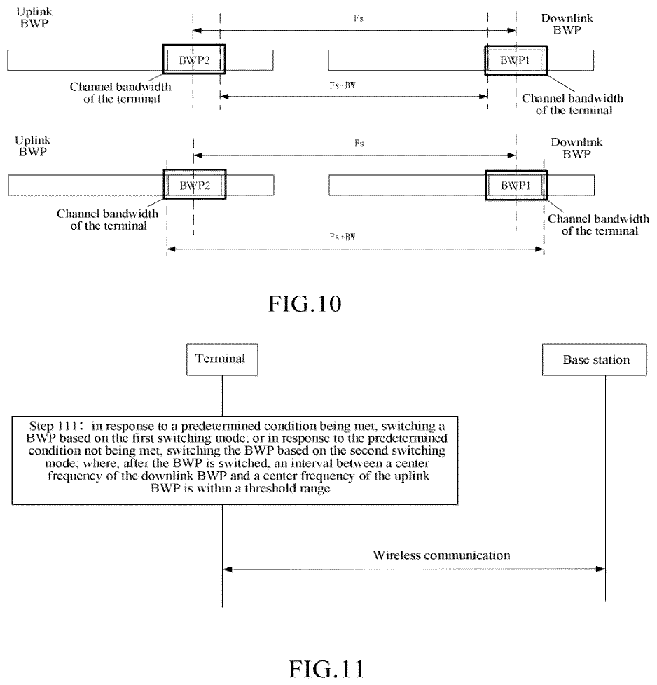

In one embodiment, referring to FIG. 10, in response to determining that the mode for switching BWP is the second mode, the interval between the lowest frequency of the target downlink BWP and the highest frequency of the target uplink BWP is greater than X3, where X3=Fs−BW; and/or, the interval between the highest frequency of the target downlink BWP and the lowest frequency of the target uplink BWP is less than X4, where X4=Fs+BW.

In the embodiment of the present disclosure, the switching mode for switching the bandwidth part BWP is determined according to a predetermined condition. The switching mode includes: a first switching mode for switching the downlink BWP or the uplink BWP; and a second switching mode for switching the downlink BWP and the uplink BWP. Here, it can be determined whether to switch the BWP through the first switching mode or the second switching mode according to the predetermined condition. Compared with the BWP switching using a single switching mode, the BWP switching is more flexible and can ensure that the frequency interval between the uplink BWP and the downlink BWP meets the communication requirement, so that the terminal can send and receive data at the same time, thereby improving the reliability of wireless communication.

It should be noted that those skilled in the art can understand that the method provided in the embodiment of the present disclosure can be executed alone or together with some methods in the embodiment of the present disclosure or some methods in related art.

As shown in FIG. 11, a method for switching BWP is provided in an embodiment. The method includes:
Step 111, in response to a predetermined condition being met, switching a BWP based on the first switching mode;
or,
in response to the predetermined condition not being met, switching the BWP based on the second switching mode;
where, after the BWP is switched, an interval between a center frequency of the downlink BWP and a center frequency of the uplink BWP is within a threshold range.

In one embodiment, according to the predetermined condition, the switching mode for switching the bandwidth part BWP is determined. The switching mode includes: a first switching mode for switching the downlink BWP or the uplink BWP; and a second switching mode for switching the downlink BWP and the uplink BWP. In response to the predetermined condition being met, the BWP is switched based on the first switching mode; or, in response to the predetermined condition not being met, the BWP is switched based on the second switching mode.

In one embodiment, the predetermined condition includes: an interval between a reference frequency of a target uplink BWP for performing BWP switching based on the first switching mode and a reference frequency of an activated downlink BWP is within a threshold range; or, an interval between a reference frequency of a target downlink BWP for performing BWP switching based on the first switching mode and a reference frequency of an activated uplink BWP is within a threshold range.

In one embodiment, the terminal is currently operating in an activated uplink BWP and an activated downlink BWP and needs to perform an uplink BWP switch. In response to the interval between the reference frequency of the target uplink BWP for performing BWP switching based on the first switching mode and the reference frequency of the activated downlink BWP is within the threshold range, the predetermined condition is determined to be met; and the BWP is switched based on the first switching mode.

In one embodiment, the terminal is currently operating in an activated uplink BWP and an activated downlink BWP and needs to perform a downlink BWP switch. In response to the interval between the reference frequency of the target downlink BWP for performing BWP switching based on the first switching mode and the reference frequency of the activated uplink BWP being within the threshold range, it is determined that the predetermined condition is met; and the BWP is switched based on the first switching mode.

In one embodiment, the terminal is currently operating in an activated uplink BWP and an activated downlink BWP and needs to perform the uplink BWP switching. In response to the interval between the reference frequency of the target uplink BWP for performing BWP switching based on the first switching mode and the reference frequency of the activated downlink BWP being not within the threshold range, it is determined that the predetermined condition is not met; and the BWP is switched based on the second switching mode.

In one embodiment, the terminal is currently operating in an activated uplink BWP and an activated downlink BWP and needs to perform a downlink BWP switching. In response to the interval between the reference frequency of the target downlink BWP for performing BWP switching based on the first switching mode and the reference frequency of the activated uplink BWP being not within the threshold range, it is determined that the predetermined condition is not met; and the BWP is switched based on the second switching mode.

In one embodiment, the reference frequency may be a frequency determined according to the center frequency. The threshold range may be a range determined according to a predetermined range. For example, the reference frequency may be the center frequency, and the threshold range may be the predetermined range.

It should be noted that those skilled in the art may understand that the method provided in the embodiment of the present disclosure may be performed alone or together with some methods in the embodiment of the present disclosure or some methods in related art.

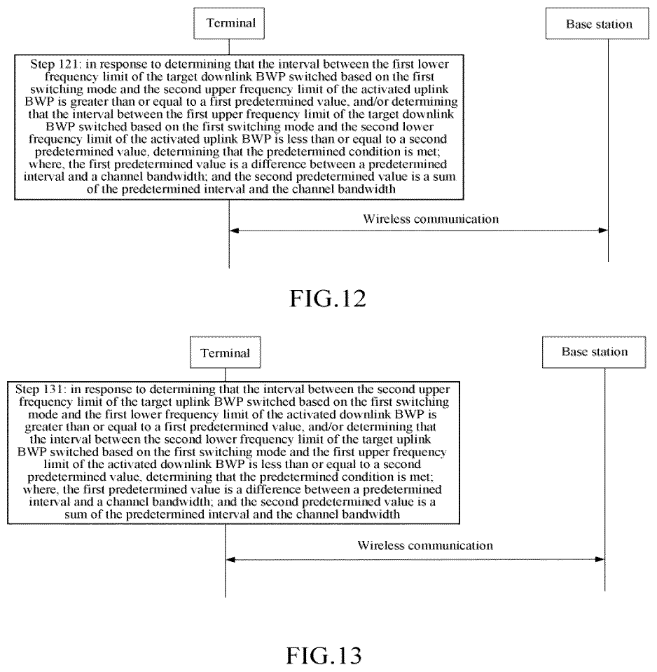

As shown in FIG. 12, a method for switching BWP is provided in the present embodiment. The method includes:
Step 121, in response to determining that the interval between the first lower frequency limit of the target downlink BWP switched based on the first switching mode and the second upper frequency limit of the activated uplink BWP is greater than or equal to a first predetermined value, and/or determining that the interval between the first upper frequency limit of the target downlink BWP switched based on the first switching mode and the second lower frequency limit of the activated uplink BWP is less than or equal to a second predetermined value, determining that the predetermined condition is met;
where, the first predetermined value is the difference between the predetermined interval and the channel bandwidth; and the second predetermined value is the sum of the predetermined interval and the channel bandwidth.

It should be noted that this embodiment may be applied to a scenario where the downlink BWP position is configured after the uplink BWP position.

In one embodiment, the terminal currently uses an uplink BWP and a downlink BWP. If it is triggered to switch the downlink BWP, this is a scenario for switching the current downlink BWP. For the scenario where the current downlink BWP needs to be switched, the downlink BWP to be switched to is the target downlink BWP. Please refer to FIG. 6 again. The reference frequency of the target downlink BWP for performing BWP switching based on the first switching mode may include the second upper frequency limit of the BWP and the second lower frequency limit of the BWP. Here, the second upper frequency limit may be the highest frequency of the BWP, and the second lower frequency limit may be the lowest frequency of the BWP. The reference frequency of the activated uplink BWP may include the first upper frequency limit and the first lower frequency limit of the BWP. Here, the first upper frequency limit may be the highest frequency of the BWP, and the first lower frequency limit may be the lowest frequency of the BWP.

For example, please refer to FIG. 6 again. Under the predetermined bandwidth, the preset interval of sending and receiving data is Fs MHz (Tx-Rx separation), and the channel bandwidth of the terminal is BW. If the interval between the first lower frequency limit and the second upper frequency limit is greater than or equal to X1, where X3=Fs−BW; and/or, the interval between the first upper frequency limit and the second lower frequency limit is less than or equal to X4, where X4−Fs+BW, then the predetermined condition is met. In response to the predetermined condition being met, the BWP is switched based on the first switching mode.

It should be noted that in response to determining that the interval between the first lower frequency limit of the target downlink BWP switched based on the first switching mode and the second upper frequency limit of the activated uplink BWP is less than the first predetermined value, and/or determining that the interval between the first upper frequency limit of the target downlink BWP switched based on the first switching mode and the second lower frequency limit of the activated uplink BWP is greater than the second predetermined value, it is determined that the predetermined condition is not met.

It should be noted that those skilled in the art can understand that the method provided in the embodiment of the present disclosure can be executed alone or together with some methods in the embodiment of the present disclosure or some methods in related art.

In one embodiment, in response to determining that the interval between the first upper frequency limit of the target downlink BWP switched based on the first switching mode and the second lower frequency limit of the activated uplink BWP is greater than or equal to the first predetermined value, and/or determining that the interval between the first lower frequency limit of the target downlink BWP switched based on the first switching mode and the second upper frequency limit of the activated uplink BWP is less than or equal to the second predetermined value, it is determined that the predetermined condition is met;
where, the first predetermined value is the difference between the predetermined interval and the channel bandwidth; and the second predetermined value is the sum of the predetermined interval and the channel bandwidth.

As shown in FIG. 13, a method for switching BWP is provided in this embodiment. The method includes:
Step 131, in response to determining that the interval between the second upper frequency limit of the target uplink BWP switched based on the first switching mode and the first lower frequency limit of the activated downlink BWP is greater than or equal to the first predetermined value, and/or determining that the interval between the second lower frequency limit of the target uplink BWP switched based on the first switching mode and the first upper frequency limit of the activated downlink BWP is less than or equal to the second predetermined value, determining that the predetermined condition is met;
where, the first predetermined value is the difference between the predetermined interval and the channel bandwidth; and the second predetermined value is the sum of the predetermined interval and the channel bandwidth.

It should be noted that this embodiment can be applied to a scenario where the downlink BWP position is configured after the uplink BWP position.

In one embodiment, the terminal currently uses an uplink BWP and a downlink BWP. If it is triggered to switch the uplink BWP, this is a scenario for switching the current uplink BWP. For the scenario where the current uplink BWP needs to be switched, the uplink BWP to be switched to is the target uplink BWP. Please refer to FIG. 6 again. The reference frequency of the target uplink BWP for performing BWP switching based on the first switching mode may include the second upper frequency limit of the BWP and the second lower frequency limit of the BWP. Here, the second upper frequency limit may be the highest frequency of the BWP, and the second lower frequency limit may be the lowest frequency of the BWP. The reference frequency of the activated downlink BWP may include the first upper frequency limit and the first lower frequency limit of the BWP. Here, the first upper frequency limit may be the highest frequency of the BWP, and the first lower frequency limit may be the lowest frequency of the BWP.

For example, for the scenario where the current uplink BWP needs to be switched, please refer to FIG. 6 again. Under the predetermined bandwidth, the preset interval for sending and receiving data is Fs MHz (Tx-Rx separation), and the channel bandwidth of the terminal is BW. If the interval between the first lower frequency limit and the second upper frequency limit is greater than X1, where X1=Fs−BW; and/or the interval between the first upper frequency limit and the second lower frequency limit is less than X2, where X2=Fs+BW, then the predetermined condition is met. In response to the predetermined condition being met, the BWP is switched based on the first switching mode.

It should be noted that in response to determining that the interval between the second upper frequency limit of the target uplink BWP switched based on the first switching mode and the first lower frequency limit of the activated downlink BWP is less than the first predetermined value, and/or determining that the interval between the second lower frequency limit of the target uplink BWP switched based on the first switching mode and the first upper frequency limit of the activated downlink BWP is greater than the second predetermined value, it is determined that the predetermined condition is not met.

It should be noted that those skilled in the art can understand that the method provided in the embodiment of the present disclosure can be executed alone or together with some methods in the embodiment of the present disclosure or some methods in the related art.

In one embodiment, for a scenario where the downlink BWP position is configured before the uplink BWP position. In response to determining that the interval between the second lower frequency limit of the target uplink BWP switched based on the first switching mode and the first upper frequency limit of the activated downlink BWP is greater than or equal to the first predetermined value, and/or determining that the interval between the second upper frequency limit of the target uplink BWP switched based on the first switching mode and the first lower frequency limit of the activated downlink BWP is less than or equal to the second predetermined value, it is determined that the predetermined condition is met;
wherein, the first predetermined value is the difference between the predetermined interval and the channel bandwidth; and the second predetermined value is the sum of the predetermined interval and the channel bandwidth.

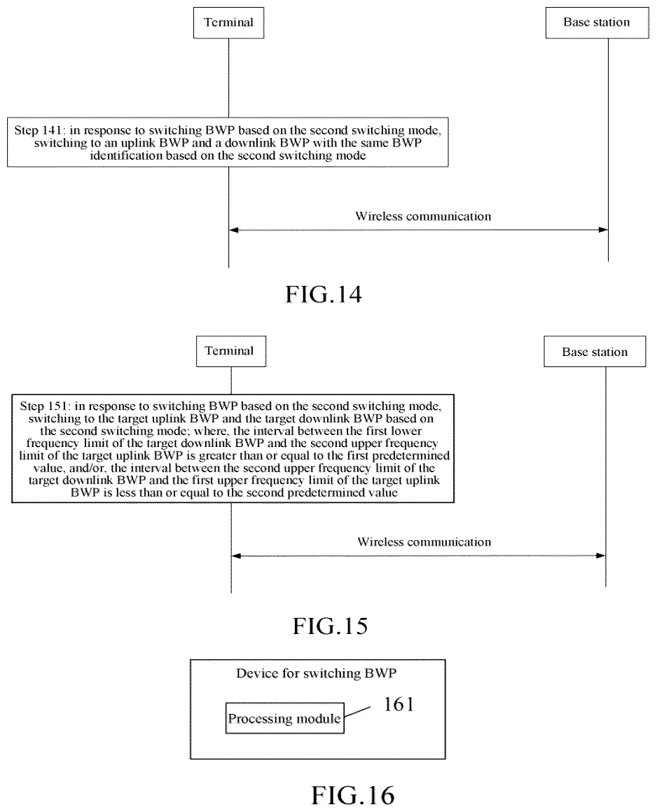

As shown in FIG. 14, a method for switching BWP is provided in this embodiment. The method includes:
Step 141, in response to switching BWP based on the second switching mode, switching to an uplink BWP and a downlink BWP with the same BWP identification based on the second switching mode.

In one embodiment, according to a predetermined condition, a switching mode for switching the bandwidth part BWP is determined. The switching mode includes: a first switching mode for switching the downlink BWP or the uplink BWP; and a second switching mode for switching the downlink BWP and the uplink BWP. The predetermined condition includes: the interval between the reference frequency of the target uplink BWP for performing BWP switching based on the first switching mode and the reference frequency of the activated downlink BWP is within a threshold range; or, the interval between the reference frequency of the target downlink BWP for performing BWP switching based on the first switching mode and the reference frequency of the activated uplink BWP is within a threshold range. In response to switching the BWP based on the second switching mode, switching to the uplink BWP and the downlink BWP with the same BWP identification is performed based on the second switching mode.

In one embodiment, the interval between the reference frequency of the downlink BWP and the reference frequency of the uplink BWP is within a threshold range, where the downlink BWP and the uplink BWP are configured with the same BWP identification.

In one embodiment, in response to not meeting the predetermined condition, determining the switching mode for switching the bandwidth part BWP to be the second mode. When the terminal receives downlink scheduling downlink control information (DCI), simultaneous switching of the downlink BWP and the uplink BWP based on the second mode is performed. In one embodiment, the BWP identifications of the target downlink BWP and the target uplink BWP for switching are the same. That is, after the switching is completed, the BWP identifications of the activated target downlink BWP and the activated uplink BWP are the same.

It should be noted that those skilled in the art can understand that the method provided in the embodiment of the present disclosure can be executed alone or together with some methods in the embodiment of the present disclosure or some methods in related art.

As shown in FIG. 15, a method for switching BWP is provided in this embodiment. The method includes:
Step 151, in response to switching BWP based on the second switching mode, switching to the target uplink BWP and the target downlink BWP based on the second switching mode;
wherein, the interval between the first lower frequency limit of the target downlink BWP and the second upper frequency limit of the target uplink BWP is greater than or equal to the first predetermined value, and/or, the interval between the second upper frequency limit of the target downlink BWP and the first upper frequency limit of the target uplink BWP is less than or equal to the second predetermined value.

In one embodiment, the switching mode for switching the bandwidth part BWP is determined according to a predetermined condition. The switching mode includes: a first switching mode for switching downlink BWP or uplink BWP; and a second switching mode for switching downlink BWP and uplink BWP. The predetermined condition includes: the interval between the reference frequency of the target uplink BWP for performing BWP switching based on the first switching mode and the reference frequency of the activated downlink BWP is within a threshold range; or, the interval between the reference frequency of the target downlink BWP for performing BWP switching based on the first switching mode and the reference frequency of the activated uplink BWP is within a threshold range. In response to switching BWP based on the second switching mode, it is switched to the target uplink BWP and the target downlink BWP based on the second switching mode; where the interval between the first lower frequency limit of the target downlink BWP and the second upper frequency limit of the target uplink BWP is greater than or equal to the first predetermined value, and/or, the interval between the second upper frequency limit of the target downlink BWP and the first upper frequency limit of the target uplink BWP is less than or equal to the second predetermined value.

It should be noted that those skilled in the art can understand that the method provided in the embodiment of the present disclosure can be executed alone or together with some methods in the embodiment of the present disclosure or some methods in related art.

As shown in FIG. 16, a device for switching BWP is provided in the embodiment of the present disclosure, applied in a terminal. The device includes:
a processing module 161 configured to determine a switching mode for switching a bandwidth part BWP according to a predetermined condition;
where the switching mode includes: a first switching mode for switching a downlink BWP or an uplink BWP; and a second switching mode for switching a downlink BWP and an uplink BWP.

In one embodiment, the predetermined condition includes: the interval between the reference frequency of the target uplink BWP for performing BWP switching based on the first switching mode and the reference frequency of the activated downlink BWP is within the threshold range; or, the interval between the reference frequency of the target downlink BWP for performing BWP switching based on the first switching mode and the reference frequency of the activated uplink BWP is within the threshold range.

In one embodiment, the processing module 161 is further configured to:
switch the BWP based on the first switching mode in response to the predetermined condition being met;
or,
switch the BWP based on the second switching mode in response to the predetermined condition not being met;
where, after the BWP switching, the interval between the center frequency of the downlink BWP and the center frequency of the uplink BWP is within the predetermined range.

In one embodiment, the processing module 161 is further configured to:
in response to determining that the interval between the first lower frequency limit of the target downlink BWP switched based on the first switching mode and the second upper frequency limit of the activated uplink BWP is greater than or equal to the first predetermined value, and/or, determining that the interval between the first upper frequency limit of the target downlink BWP switched based on the first switching mode and the second lower frequency limit of the activated uplink BWP is less than or equal to the second predetermined value, determine that the predetermined condition is met;
where, the first predetermined value is the difference between the predetermined interval and the channel bandwidth; and the second predetermined value is the sum of the predetermined interval and the channel bandwidth.

In one embodiment, the processing module 161 is further configured to:
in response to determining that the interval between the second upper frequency limit of the target uplink BWP switched based on the first switching mode and the first lower frequency limit of the activated downlink BWP is greater than or equal to the first predetermined value, and/or, determining that the interval between the second lower frequency limit of the target uplink BWP switched based on the first switching mode and the first upper frequency limit of the activated downlink BWP is less than or equal to the second predetermined value, determine that the predetermined condition is met;
where, the first predetermined value is the difference between the predetermined interval and the channel bandwidth; and the second predetermined value is the sum of the predetermined interval and the channel bandwidth.

In one embodiment, the interval between the reference frequency of the downlink BWP and the reference frequency of the uplink BWP is a predetermined interval, where the downlink BWP and the uplink BWP are configured with the same BWP identification.

In one embodiment, the processing module 161 is further configured to:
in response to switching the BWP based on the second switching mode, switch to the uplink BWP and the downlink BWP with the same BWP identification based on the second switching mode.

In one embodiment, the processing module 161 is further configured to:
in response to switching the BWP based on the second switching mode, switch to the target uplink BWP and the target downlink BWP based on the second switching mode;
wherein, the interval between the first lower frequency limit of the target downlink BWP and the second upper frequency limit of the target uplink BWP is greater than or equal to the first predetermined value, and/or, the interval between the second upper frequency limit of the target downlink BWP and the first upper frequency limit of the target uplink BWP is less than or equal to the second predetermined value.

It should be noted that those skilled in the art can understand that the method provided in the embodiment of the present disclosure can be executed alone or together with some methods in the embodiment of the present disclosure or some methods in related art.

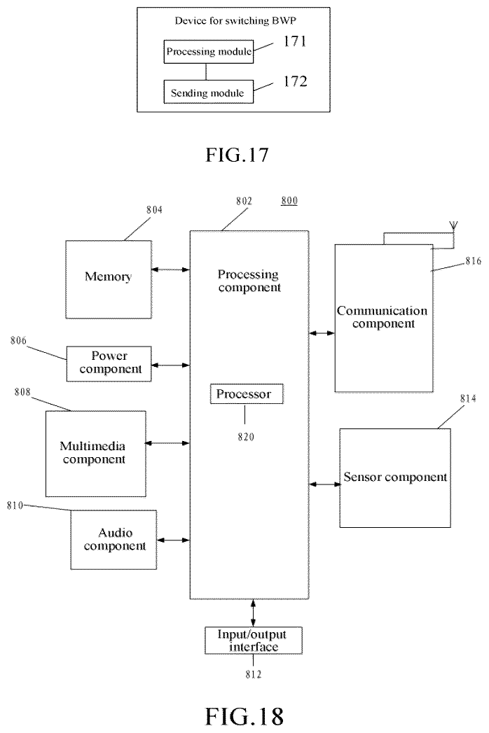

As shown in FIG. 17, a device for switching BWP is provided in an embodiment of the present disclosure, applied in a base station. The device includes:
a processing module 171 configured to determine a switching mode for switching a bandwidth part BWP;
wherein, the switching mode includes a first switching mode for switching downlink BWP or uplink BWP; and a second switching mode for switching downlink BWP and uplink BWP;
a sending module 172 configured to send information indicating the switching mode to a terminal.

In one embodiment, the processing module 171 is further configured to:
determine the switching mode for switching BWP according to a predetermined condition;
wherein, the predetermined condition includes: the interval between the reference frequency of the target uplink BWP for performing BWP switching based on the first switching mode and the reference frequency of the activated downlink BWP is within a threshold range; or, the interval between the reference frequency of the target downlink BWP for performing BWP switching based on the first switching mode and the reference frequency of the activated uplink BWP is within a threshold range.

In one embodiment, the processing module 171 is further configured to:
in response to the predetermined condition being met, switch the BWP based on the first switching mode;
or,
in response to the predetermined condition not being met, switch the BWP based on the second switching mode;
wherein, after the BWP is switched, the interval between the center frequency of the downlink BWP and the center frequency of the uplink BWP is within the threshold range.

In one embodiment, the processing module 171 is further configured to:
in response to determining that the interval between the first lower frequency limit of the target downlink BWP switched based on the first switching mode and the second upper frequency limit of the activated uplink BWP is greater than or equal to the first predetermined value, and/or, determining that the interval between the first upper frequency limit of the target downlink BWP switched based on the first switching mode and the second lower frequency limit of the activated uplink BWP is less than or equal to the second predetermined value, determine that the predetermined condition is met;
wherein, the first predetermined value is the difference between the predetermined interval and the channel bandwidth; and the second predetermined value is the sum of the predetermined interval and the channel bandwidth.

In one embodiment, the processing module 171 is further configured to:
in response to determining that the interval between the second upper frequency limit of the target uplink BWP switched based on the first switching mode and the first lower frequency limit of the activated downlink BWP is greater than or equal to the first predetermined value, and/or, determining that the interval between the second lower frequency limit of the target uplink BWP switched based on the first switching mode and the first upper frequency limit of the activated downlink BWP is less than or equal to the second predetermined value, determine that the predetermined condition is met;
wherein, the first predetermined value is the difference between the predetermined interval and the channel bandwidth; and the second predetermined value is the sum of the predetermined interval and the channel bandwidth.

In one embodiment, the interval between the reference frequency of the downlink BWP and the reference frequency of the uplink BWP is the predetermined interval, where the downlink BWP and the uplink BWP are configured with the same BWP identification.

In one embodiment, the processing module 171 is further configured to:
in response to switching the BWP based on the second switching mode, switch to the uplink BWP and the downlink BWP with the same BWP identification based on the second switching mode.

In one embodiment, the processing module 171 is further configured to:
in response to switching the BWP based on the second switching mode, switch to the target uplink BWP and the target downlink BWP based on the second switching mode;
wherein, the interval between the first lower frequency limit of the target downlink BWP and the second upper frequency limit of the target uplink BWP is greater than or equal to the first predetermined value, and/or, the interval between the second upper frequency limit of the target downlink BWP and the first upper frequency limit of the target uplink BWP is less than or equal to the second predetermined value.

The embodiment of the present disclosure provides a communication device. The communication device includes:
a processor;
a memory configured to store processor executable instructions;
where, the processor is configured to: implement the method applied to any embodiment of the present disclosure when running the executable instructions.

The processor may include various types of storage media, which are non-transitory computer storage media, and can continue to memorize the information stored thereon after the communication device is powered off.

The processor can be connected to the memory through a bus, etc., for reading the executable program stored on the memory.

The embodiment of the present disclosure also provides a computer storage medium. The computer storage medium stores a computer executable program, and the executable program implements the method of any embodiment of the present disclosure when executed by the processor.

Regarding the device in the above embodiments, the specific manner in which each module performs the operation has been described in detail in the embodiment of the method, and will not be repeated here.

As shown in FIG. 18, an embodiment of the present disclosure provides a structure of a terminal.

Referring to the terminal 800 shown in FIG. 18, this embodiment provides a terminal 800, which can be a mobile phone, a computer, a digital broadcast terminal, a message transceiver device, a game console, a tablet device, a medical device, a fitness device, a personal digital assistant, etc.

Referring to FIG. 18, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operation of the terminal 800, such as operations associated with display, phone calls, data communications, camera operations, and recording operations. The processing component 802 may include one or more processors 820 to execute instructions to complete all or part of the steps of the above method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations on the device 800. Examples of such data include instructions for any application or method operating on the terminal 800, contact data, phone book data, messages, pictures, videos, etc. The memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 806 provides power to various components of the terminal 800. The power component 806 may include a power management system, one or more power supplies, and other components associated with generating, managing and distributing power to the terminal 800.

The multimedia component 808 includes a screen that provides an output interface between the terminal 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundary of the touch or slide action, but also detect the duration and pressure associated with the touch or slide operation. In some embodiments, the multimedia component 808 includes a front camera and/or a rear camera. When the device 800 is in an operating mode, such as a shooting mode or a video mode, the front camera and/or the rear camera may receive external multimedia data. Each of the front camera and the rear camera may be a fixed optical lens system or have a focal length and optical zoom capability.

The audio component 810 is configured to output and/or input audio signals. For example, the audio component 810 includes a microphone (MIC). When the terminal 800 is in an operating mode, such as a call mode, a recording mode, and a voice recognition mode, the microphone is configured to receive external audio signals. The received audio signal may be further stored in the memory 804 or sent via the communication component 816. In some embodiments, the audio component 810 further includes a speaker for outputting the audio signal.

The I/O interface 812 provides an interface between the processing component 802 and the peripheral interface module. The peripheral interface module may be a keyboard, a click wheel, a button, etc. These buttons may include, but are not limited to, a home button, a volume button, a start button, and a lock button.

The sensor component 814 includes one or more sensors for providing various aspects of status assessment for the terminal 800. For example, the sensor component 814 may detect the open/closed state of the device 800. The sensor component 814 may the relative positioning of components, and the components are for example the display and keypad of the terminal 800. The sensor component 814 may also detect the position change of the terminal 800 or a component of the terminal 800, the presence or absence of contact between the user and the terminal 800, the orientation or acceleration/deceleration of the terminal 800, and the temperature change of the terminal 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer, a gyroscope, a magnetic sensor, a pressure sensor, or a temperature sensor.

The communication component 816 is configured to facilitate wired or wireless communication between the terminal 800 and other devices. The terminal 800 can access a wireless network based on a communication standard, such as Wi-Fi, 2G or 3G, or a combination thereof. In an exemplary embodiment, the communication component 816 receives a broadcast signal or broadcast-related information from an external broadcast management system via a broadcast channel. In an exemplary embodiment, the communication component 816 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology, and other technologies.

In an exemplary embodiment, the terminal 800 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above method.

In an exemplary embodiment, a non-transitory computer-readable storage medium including instructions is also provided, such as a memory 804 including instructions, and the above instructions can be executed by a processor 820 of the terminal 800 to complete the above method. For example, the non-transitory computer-readable storage medium can be a ROM, a random access memory (RAM), a CD-ROM, a tape, a floppy disk, and an optical data storage device, etc.

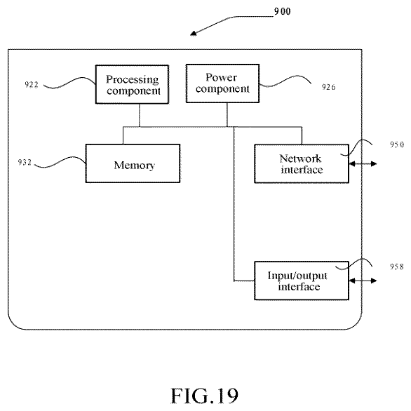

As shown in FIG. 19, an embodiment of the present disclosure shows a structure of a base station. For example, the base station 900 can be provided as a network-side device. Referring to FIG. 19, the base station 900 includes a processing component 922, which further includes one or more processors, and a memory resource represented by a memory 932 for storing instructions that can be executed by the processing component 922, such as an application. The application stored in the memory 932 may include one or more modules each corresponding to a set of instructions. In addition, the processing component 922 is configured to execute instructions to perform any of the above methods applied to the base station.

The base station 900 may also include a power component 926 configured to perform power management of the base station 900; a wired or wireless network interface 950 configured to connect the base station 900 to the network; and an input/output (I/O) interface 958. The base station 900 may operate based on an operating system stored in the memory 932, such as Windows Server™, Mac OS X™, Unix™, Linux™, FreeBSD™ or the like.

Other embodiments of the present invention will be easily conceived by those skilled in the art after considering the specification and practicing the disclosure herein. The present disclosure is intended to cover any variation, use or adaptation of the present disclosure, which follows the general principles of the present disclosure and includes common knowledge or conventional technical means in the art that are not disclosed in the present disclosure. The description and embodiments are to be regarded as exemplary only, and the true scope and spirit of the present disclosure are indicated by the following claims.

It should be understood that the present disclosure is not limited to the precise structure described above and shown in the drawings, and various modifications and changes can be made without departing from its scope. The scope of the present disclosure is limited only by the accompanying claims.

1. A method for switching a bandwidth part (BWP), the method being performed by a terminal, and comprising:
determining a switching mode for switching the BWP,
wherein the switching mode comprises a first switching mode for switching a downlink BWP or an uplink BWP and a second switching mode for switching the downlink BWP and the uplink BWP.

2. The method according to claim 1, wherein determining the switching mode for switching the BWP comprises:
determining the switching mode for switching the BWP according to a predetermined condition,
wherein the predetermined condition comprises: an interval between a reference frequency of a target uplink BWP for performing BWP switching based on the first switching mode and a reference frequency of an activated downlink BWP is within a threshold range; or an interval between a reference frequency of a target downlink BWP for performing BWP switching based on the first switching mode and a reference frequency of an activated uplink BWP is within the threshold range.

3. The method according to claim 2, wherein determining the switching mode for switching the BWP according to the predetermined condition comprises:
in response to the predetermined condition being met, switching the BWP based on the first switching mode; or
in response to the predetermined condition not being met, switching the BWP based on the second switching mode,
wherein after the BWP is switched, an interval between a center frequency of the downlink BWP and a center frequency of the uplink BWP is within the threshold range.

4. The method according to claim 3, further comprising:
in response to at least one of determining that an interval between a first lower frequency limit of the target downlink BWP switched based on the first switching mode and a second upper frequency limit of the activated uplink BWP is greater than or equal to a first predetermined value, or determining that an interval between a first upper frequency limit of the target downlink BWP switched based on the first switching mode and a second lower frequency limit of the activated uplink BWP is less than or equal to a second predetermined value, determining that the predetermined condition is met,
wherein the first predetermined value is a difference between a predetermined interval and a channel bandwidth and the second predetermined value is a sum of the predetermined interval and the channel bandwidth.

5. The method according to claim 3, further comprising:
in response to at least one of determining that an interval between a second upper frequency limit of the target uplink BWP switched based on the first switching mode and a first lower frequency limit of the activated downlink BWP is greater than or equal to a first predetermined value, or determining that an interval between a second lower frequency limit of the target uplink BWP switched based on the first switching mode and a first upper frequency limit of the activated downlink BWP is less than or equal to a second predetermined value, determining that the predetermined condition is met,
wherein the first predetermined value is a difference between a predetermined interval and a channel bandwidth and the second predetermined value is a sum of the predetermined interval and the channel bandwidth.

6. The method according to claim 3, wherein the interval between the reference frequency of the downlink BWP and the reference frequency of the uplink BWP is a predetermined interval, and the downlink BWP and the uplink BWP are configured with a same BWP identification.

7. The method according to claim 6, further comprising:
in response to switching the BWP based on the second switching mode, switching to the uplink BWP and the downlink BWP with the same BWP identification based on the second switching mode.

8. The method according to claim 3, further comprising:
in response to switching the BWP based on the second switching mode, switching to the target uplink BWP and the target downlink BWP based on the second switching mode,
wherein at least one of the following holds true; the interval between the first lower frequency limit of the target downlink BWP and the second upper frequency limit of the target uplink BWP is greater than or equal to a first predetermined value, or the interval between the second upper frequency limit of the target downlink BWP and the first upper frequency limit of the target uplink BWP is less than or equal to a second predetermined value.

9. A method for switching a bandwidth part (BWP), the method being performed by a base station, and comprising:
determining a switching mode for switching the BWP,
wherein the switching mode comprises a first switching mode for switching a downlink BWP or an uplink BWP and a second switching mode for switching the downlink BWP and the uplink BWP; and
sending information indicating the switching mode to a terminal.

10. The method according to claim 2, wherein determining the switching mode for switching the BWP comprises:
determining the switching mode of switching the BWP according to a predetermined condition,
wherein the predetermined condition comprises: an interval between a reference frequency of a target uplink BWP for performing BWP switching based on the first switching mode and a reference frequency of an activated downlink BWP is within a threshold range; or an interval between a reference frequency of a target downlink BWP for performing BWP switching based on the first switching mode and a reference frequency of an activated uplink BWP is within the threshold range.

11. The method according to claim 10, wherein determining the switching mode for switching the BWP according to the predetermined condition comprises:
switching the BWP based on the first switching mode in response to the predetermined condition being met; or
switching the BWP based on the second switching mode in response to the predetermined condition not being met,
wherein after the BWP switching, an interval between a center frequency of the downlink BWP and a center frequency of the uplink BWP is within the threshold range.

12. The method according to claim 11, further comprising:
in response to at least one of determining that an interval between a first lower frequency limit of the target downlink BWP switched based on the first switching mode and a second upper frequency limit of the activated uplink BWP is greater than or equal to a first predetermined value, or determining that an interval between a first upper frequency limit of the target downlink BWP switched based on the first switching mode and a second lower frequency limit of the activated uplink BWP is less than or equal to a second predetermined value, determining that the predetermined condition is met,
wherein the first predetermined value is a difference between a predetermined interval and a channel bandwidth and the second predetermined value is a sum of the predetermined interval and the channel bandwidth.

13. The method according to claim 11, further comprising:
in response to at least one of determining that an interval between a second upper frequency limit of the target uplink BWP switched based on the first switching mode and a first lower frequency limit of the activated downlink BWP is greater than or equal to a first predetermined value, or determining that an interval between a second lower frequency limit of the target uplink BWP switched based on the first switching mode and a first upper frequency limit of the activated downlink BWP is less than or equal to a second predetermined value, determining that the predetermined condition is met,
wherein the first predetermined value is a difference between a predetermined interval and a channel bandwidth and the second predetermined value is a sum of the predetermined interval and the channel bandwidth.

14. The method according to claim 11, wherein the interval between the reference frequency of the downlink BWP and the reference frequency of the uplink BWP is a predetermined interval, and the downlink BWP and the uplink BWP are configured with a same BWP identification.

15. The method according to claim 14, further comprising:
in response to switching the BWP based on the second switching mode, switching to the uplink BWP and the downlink BWP with the same BWP identification based on the second switching mode.

16. The method according to claim 11, further comprising:
in response to switching the BWP based on the second switching mode, switching to the target uplink BWP and the target downlink BWP based on the second switching mode,
wherein at least one of the following holds true; an interval between a first lower frequency limit of the target downlink BWP and a second upper frequency limit of the target uplink BWP is greater than or equal to a first predetermined value, or an interval between a second upper frequency limit of the target downlink BWP and a first upper frequency limit of the target uplink BWP is less than or equal to a second predetermined value.

17-32. (canceled)

33. A communication device, comprising:
a memory; and
a processor coupled to the memory,
wherein the processor, when executing computer executable instructions stored on the memory, causes the communication device to
determine a switching mode for switching a bandwidth part (BWP),
wherein the switching mode comprises a first switching mode for switching a downlink BWP or an uplink BWP and a second switching mode for switching the downlink BWP and the uplink BWP.

34. A non-transitory computer-readable storage medium; storing computer executable instructions, wherein the computer executable instructions implement the method according to claim 1 after being executed by a processor.

35. A communication device, comprising:
a memory; and
a processor coupled to the memory,
wherein the processor, when executing computer executable instructions stored on the memory, causes the communication device to implement the method according to claim 9.

36. A non-transitory computer-readable storage medium storing computer executable instructions, wherein the computer executable instructions implement the method according to claim 9 after being executed by a processor.
